(19) United States
(12) Patent Application Publication
(10) Pub. No.: US 2014/0358911 A1
(43) Pub. Date: Dec. 4, 2014

(54) SEARCH AND DISCOVERY SYSTEM

(71) Applicants: Kevin McCarthy, Co. Wexford (IE); Owen Phelan, Dublin (IE); Barry Smyth, Co. Wicklow Greystones (IE)

(72) Inventors: Kevin McCarthy, Co. Wexford (IE); Owen Phelan, Dublin (IE); Barry Smyth, Co. Wicklow Greystones (IE)

(73) Assignee: University College Dublin, National Uniaversity of Ireland, Dublin (IE)

(21) Appl. No.: 14/342,042

(22) PCT Filed: Aug. 24, 2012
(86) PCT No.: PCT/EP2012/066547

§ 371 Date: Jul. 8, 2014

Related U.S. Application Data
(60) Provisional application No. 61/529,829, filed on Aug. 31, 2011.

(51) Int. Cl. G06F 17/30

(52) U.S. Cl. CPC G06F 17/30867; G06F 17/30321
USPC 707/723; 707/741

(57) ABSTRACT

A system for search and discovery of information in a real time network, comprising: means for gathering data indicative of a message posted in an real time network, the data comprising information identifying a uniform resource locator, URL and textual information associated with the URL; means for indexing the gathered data; means for querying the indexed data; and means for ranking the queried data.

### FIELD OF THE INVENTION

The present invention is directed to a search and discovery system for informational or real time networks.

### BACKGROUND TO THE INVENTION

Social networks and the Real-time Web (RTW) have joined Search and Discovery as central pillars of online human activities. These are staple venues of interaction, with vast social graphs facilitating messaging and sharing of information. One example of such a social network is Twitter™, which, for example, boasts 200 million users posting over 200 million messages everyday.

Social network activity dominates traffic and per-user expended time on the web (Haewoom Kwak, Changhyun Lee, Hosung Park, and Sue Moon. What is twitter, a social network or a news media? WWW '10, pages 591-600, 2010.) RTW services provide access to new types of information and the real-time nature of these data streams provide as many opportunities as they do challenges. Companies like Twitter, Inc, have adopted a very open approach to making their data available via APIs leading to an increase in the desire to develop and understand why and how people are using services like Twitter™.

For instance, the work of Kwak et al. describes a very comprehensive analysis of Twitter™ users and Twitter™ usage, covering almost 42 million users, nearly 1.5 billion social connections, and over 100 million tweets. In that paper, reciprocity and homophily among Twitter™ users is examined and a number of different ways to evaluate user influence are compared, while investigating how information diffuses through the Twitter™ “ecosystem” as a result of social relationships and re-tweeting behaviour.

Twitter™ has previously been explored as a news discovery and recommendation service, with item discovery appearing to be a prominently useful feature (Owen Phelan, Kevin McCarthy, Mike Bennett, and Barry Smyth. Terms of a feather: content-based news recommendation and discovery using twitter. Proceedings of the 33rd European conference on Advances in information retrieval, ECIR'll, pages 448-459, Berlin, Heidelberg, 2011. Springer-Verlag. Classes of Twitter™ users have been identified based on behaviours and geographical dispersion (Balachander Krishnamurthy, Phillipa Gill, and Martin Arlin. A few chirps about twitter. In WOSP '08: Proceedings of the first workshop on Online social networks, pages 19-24, NY, USA, 2008. ACM.)

The above-mentioned references highlight the process of producing and consuming content based on re-tweet actions, where users source and disseminate information through the network.

Social networks or real time networks and social networking systems such as Twitter™, allow users to repost, or re-tweet other people's items, which allow for these links to propagate throughout the graphs of users on the service. Large numbers of posts, directed to a variety of topics, are posted daily and as such it is desirable to be able to conveniently and efficiently search, archive and access this information for curation, content-editorial and general interest.

Curation and content-editorial are age-old practices in publishing activities. News organizations operate editorial teams to filter output for relevant, interesting, topical and aesthetic content for their audiences. In terms of the domain of recommender systems, it can be considered an interesting avenue of exploration, such as to enable benchmarking against automatic or intelligent methods of item recommendation. Related to the idea of curation are the various notions of Trust, Provenance and Reputation of those who are providing input into the system. Reputation scoring is an active field in Recommender Systems (Paul Resnick, Ko Kuwabara, Richard Zeckhauser, and Eric Friedman. Reputation systems. Commun. ACM, 43:45-48, December 2000) and Social Search Systems (Oisin Boydell and Barry Smyth. Capturing community search expertise for personalized web search using snippet-indexes. Proceedings of the 15th ACM international conference on Information and knowledge management, CIKM '06, pages 277-286, New York, N.Y., USA, 2006. ACM).

In particular, focus is placed on finding reputable sources of information to extract and present content from. As an example, the TrustRank technique proposed by Gyongyi et al (Combating web spam with TrustRank. VLDB '04: Proceedings of the Thirtieth international conference on Very large data bases, pages 576-587. VLDB Endowment, 2004) computes a reputation score of elements in a web-graph with the purpose of detecting spam. Alternative explorations such as those by McNally et al. (“Towards a reputation-based model of social web search”. In Proceedings of the 15th international conference on Intelligent user interfaces, IUI '10, pages 179-188, New York, N.Y., USA, 2010. ACM) focus on computing reputable users in a social search context.

GOOGLE, BING and YAHOO!™ are household tools for finding relevant items on the web, of varying quality and relevance to the users search query or task. These systems rely on the use of automatic software “crawlers” that build query-able indexes by navigating the web of documents. These crawlers index documents based on their content, find edges between each document (hyperlinks), and perform a set of weighting and relevance calculations to decide on hubs and authorities of the web, while improving index quality.

More recently, search systems have started to introduce context into their ranking and retrieval strategies, such as location and time of document publication. These are mostly content-based (related to documents actual content), as it is difficult for a web crawler to determine the precise contextual features of a web document.

Traditional search engines almost entirely rely on the content of the hyperlinked documents themselves as a basis of storing and querying. Additional dimensionality is difficult to represent in a traditional search system. With the volume of information to be disseminated, such searching requires voluminous data storage capabilities. It is desirable, therefore, to implement a search and discovery system that harnesses the information posted by users of the social networking or informational services to increase the efficiency of search and discovery.

### SUMMARY OF THE INVENTION

It is therefore an object of the present invention to harness the real-time and voluminous information posted by users on social/real time networking or informational services sites and provide an improved search and discovery system.

A first embodiment of the present invention includes a method of storing data indicative of a message posted in a real time or informational network, the data comprising information identifying a uniform resource locator, URL, and textual information associated with the URL, the method comprising: storing at least the information identifying the URL in a database; extracting the textual information from the data; and generating a search index for the database based on the extracted textual information. Storing at least the information identifying the URL may further comprise extracting, resolving and storing the URL based on the information identifying the URL. The data may further comprise metadata associated with the posted message, and wherein generating the search index may be further based on the metadata. The metadata may comprise time information relating to the time the message was posted in the real time or informational network. The metadata may comprise location information. The metadata may comprise user profile details, details of a device on which the message is input and additional related information. The method of storing data may further comprise storing the metadata in a database. The above method according to this embodiment may further comprise: searching the real time or informational network for additional content relating to the URL; and augmenting the search index based on the URL. The method may further comprise searching one or more additional informational or real time networks for additional content relating to the URL. The method of storing may further comprise selecting a search group of one or more users of the social network; searching the search group for additional content relating to the URL; and augmenting the search index based on the URL. The search group may be expanded to include a user of one or more additional informational or social networks. The users may be selected based on predetermined user preferences. User preferences may include at least one of user interests, posted message topic, reliability, user or content recommendations, keyword searches, hashtag searches, location information or analysis of information posted by the users of the real time or informational network. The real time or informational network may be Twitter™. The posted message may comprise 140 characters. It will be appreciated that the real time or informational network may be any social messaging system for example, Facebook™ or email message.

There is also provided a computer program comprising program instructions for causing a computer program to carry out the above method which may be embodied on a record medium, carrier signal or read-only memory.

A further embodiment of the present application includes a system for storing data indicative of a message posted in a real time or informational network, the data comprising information identifying a uniform resource locator, URL and textual information associated with the URL, the system comprising: means for extracting the textual information from the data; and means for generating a search index for the message based on the extracted textual information. Means for storing at least the information identifying the URL may further comprise means for extracting, means for resolving and means for storing the URL based on the information identifying the URL. The data may further comprise metadata associated with the posted message, and wherein means for generating the search index may further comprise means for generating the search index based on the metadata. The metadata may comprise time information relating to the time the message was posted in the real time or informational network. The metadata may comprise location information. Alternatively, the metadata may comprise user profile details, device details and additional related information. The system may further comprise means for storing the metadata. The system may further comprise means for searching the real time or informational network for additional content relating to the URL; and means for augmenting the search index based on the URL. The system may further comprise means for searching one or more additional informational or real time networks for additional content relating to the URL. The system may further comprise means for selecting a search group of one or more users of the real time or informational network; means for searching the search group for additional content relating to the URL; and means for augmenting the search index based on the URL. The system may further comprise means for expanding the search group to include a user of one or more additional informational or real time networks. Users may be selected based on predetermined user preferences. User preferences may include at least one of user interests, posted message topic, reliability, user or content recommendations, keyword searches, hashtag searches, location information or analysis of information posted by the users of the social or informational network.

A further embodiment of the present invention includes a method of querying data indexed according to the method above, the method of querying comprising: parsing a search string into a computer readable format; comparing the parsed search string with the generated search index; and obtaining a search result from the indexed database based on the results of the comparison. Querying may further comprise entering the search string into a user interface. The search string may comprise a first field comprising a search query and one or more additional fields. The one or more additional fields may include temporal fields. The one or more additional fields may include location fields, topic fields, relevance fields or reputation fields. The temporal fields may be configured to provide a search range within which a search is performed. The search string may be user configurable. The search query may be a natural language field. The search result may comprise at least the information identifying the URL. Querying may further comprise searching for messages related to the search result obtained from the indexed database. Querying may also comprise ranking the search result. Ranking may comprise organising the search results based on one or more user-defined criteria. User-defined criteria may include at least one of age, popularity, longevity, location and reputation of the search results. Querying may further comprise displaying the search result on the user interface. The user interface may be a graphical user interface, a remote web service, a local application or computer system. Querying may further comprise re-ranking the results displayed based on one or more user strategies. Re-ranking strategies may include relevance, age, popularity, reputation and longevity. Querying may further comprise reformulating the query.

There is also provided a computer program comprising program instructions for causing a computer program to carry out the above querying method which may be embodied on a record medium, carrier signal or read-only memory.

A further embodiment of the present application includes a system for querying data indexed according to the above methods, the system comprising: means for parsing a search string into a computer readable format; means for comparing the parsed search string with the generated search index; and means for obtaining a search result from the indexed database based on the results of the comparison. The querying system may further comprise means for entering the search string into a user interface. The search string may comprise a first field comprising a search query and one or more additional fields. The one or more additional fields may include temporal fields. The one or more additional fields may include location fields, topic fields, relevance fields or reputation fields. The temporal fields may be configured to provide a search range within which a search is performed. The search string may be user configurable. The search query may be a natural language field. The search result may comprise at least the information identifying the URL. The querying system may further comprise means for searching for messages related to the search result obtained from the indexed database. The querying system may further comprise means for ranking the search result. The means for ranking comprises means for organising the search results based on one or more user-defined criteria. The user-defined criteria may include age, popularity, longevity, location and reputation of the search results. The querying system may further comprise means for displaying the search result on the user interface.

The user interface may be a graphical user interface, a remote web service, a local application or computer system. The querying system may further comprise means for re-ranking the results displayed based on one or more user strategies. Re-ranking strategies may include relevance, age, popularity, reputation and longevity. The querying system may further comprise means for reformulating the query.

A further embodiment of the present invention includes a system for search and discovery of information in a real time network, comprising: means for gathering data indicative of a message posted in an real time network, the data comprising information identifying a uniform resource locator, URL and textual information associated with the URL; means for generating a search index for the gathered data; means for querying the indexed data; and means for ranking the queried data. The search and discovery system may further comprise means for displaying the queried data to a system user. The means for gathering the data may comprise means for storing at least the information identifying the URL in a database; means for extracting the textual information from the data; and wherein the means for generating the search index is configured to generate a search index for the database based on the extracted textual information. Means for storing at least the information identifying the URL may further comprise means for extracting, means for resolving and means for storing the URL based on the information identifying the URL. The data may further comprise metadata associated with the posted message, and wherein means for generating the search index may further comprise means for generating the search index based on the metadata. The metadata may comprise time information relating to the time the message was posted in the real time or informational network. The metadata may comprise location information. The metadata may comprise user profile details, device details and additional related information. The system for search and discovery may further comprise means for storing the metadata. The system for search and discovery may further comprise means for searching the real time or informational network for additional content relating to the URL; and means for augmenting the search index based on the URL.

The system may further comprise means for searching one or more additional informational or real time networks for additional content relating to the URL. The search and discovery system may further comprise means for selecting a search group of one or more users of the real time or informational network; means for searching the search group for additional content relating to the URL; and means for augmenting the search index based on the URL. The system may further comprise means for expanding the search group to include a user of one or more additional informational or real time networks. The users may be selected based on predetermined user preferences. The user preferences may include at least one of user interests, posted message topic, reliability, user or content recommendations, keyword searches, hashtag searches, location information or analysis of information posted by the users of the social or informational network. The real time or informational network may be Twitter™. It will be appreciated that the real time or informational network may be any social messaging system for example, Facebook™ or email messages.

The means for querying the indexed data may comprise: means for parsing a search string into a computer readable format; means for comparing the parsed search string with the generated search index; and means for obtaining a search result from the indexed database based on the results of the comparison. The search and discovery system may further comprise means for entering the search string into a user interface. The search string may comprise a first field comprising a search query and one or more additional fields. The one or more additional fields may include temporal fields. The one or more additional fields may include location fields, topic fields, relevance fields or reputation fields. The temporal fields may be configured to provide a search range within which a search is performed. The search string may be user configurable. The search query may be a natural language field. The search result may comprise at least the information identifying the URL. The system may further comprise means for searching for messages related to the search result obtained from the indexed database. The means for ranking may comprise means for organising the search results based on one or more user-defined criteria. The user defined criteria may include at least one of age, popularity, longevity, location and reputation of the search results. The means for displaying the queried data to a system user may comprise means for displaying the search result on a user interface. The user interface may be a graphical user interface, a remote web service, a local application or computer system. The search and discovery system may further comprise means for re-ranking the results displayed based on one or more user strategies. Re-ranking strategies may include relevance, age, popularity, reputation and longevity.

A further embodiment of the present application includes a method of search and discovery of information in a real time network, comprising: gathering data indicative of a message posted in an real time network, the data comprising information identifying a uniform resource locator, URL and textual information associated with the URL; generating a search index for the gathered data; querying the indexed data; and ranking the queried data.

There is also provided a computer program comprising program instructions for causing a computer program to carry out the above search and discovery method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:

FIG. 1 depicts a sample of a message posted by a user in a real time informational network in accordance with the invention.

FIG. 2 is a system for indexing, querying and ranking information in accordance with the invention.

FIG. 3 depicts indexing information input in a real time informational network in accordance with the invention.

FIG. 4 is a user interface displaying queried search results obtained in accordance with the invention.

### DETAILED DESCRIPTION OF THE DRAWINGS

The invention is directed to harnessing sources of real time information. An example of such a source of real time information is Twitter™ which is an expansive natural resource of user-generated content. While each posted or tweeted item may only seem to comprise of only 140 characters, each item also contains a rich quantity of metadata and contextual information published in a timely manner. While for the purposes of explanation, Twitter™ is referred to below; it will be appreciated that the present application may also be applied to other sources of real-time information.

Social networks are an abundant resource of social activity and discussion. Considering Twitter™ as an example of such a network, it is estimated that an average rate of 22% of Twitter™ tweets contain a hyperlink to a document as shown in Table 1.

Depicted in Table 1 is an analysis of five public Twitter™ datasets of varying sizes, the data set comprising public tweets. These datasets have been gathered randomly between 2009 and 2011. Sample 1, 2 and 3 are focussed scrapes, specific to a set of hash tags while sample 4 and 6 are general public scrapes of the Twitter™ firehose.

TABLE 1

| | | Tweet count | |
|---|---|---|---|
| | Tweet count | (with URL) | % |
| Sample 1 | 54221 | 11964 | 22.065251 |
| Sample 2 | 1411784 | 331445 | 23.47703 |
| Sample 3 | 6924205 | 1539323 | 22.231043 |
| Sample 4 | 7453870 | 1647295 | 22.09986 |
| Sample 5 | 60042573 | 13115325 | 21.840378 |
| | Average | | 22.468298 |
| | Std. Dev. | | 0.67627121 |

It is clear from Table 1 that the percentage of user resource locater, URL, included in Tweets or posts, has held steady despite the three-fold increase of Twitter™ tweet-per-day rate in the past year, and an increase of 10 fold between 2009 and 2010. These URLs can be news items, photos, Geo-located “check-ins”, videos, as well as “vanilla” URLs to websites. With the increasing volume of information available, it is desirable to have an efficient search and retrieval system.

The present invention is directed to directly injecting user generated content into a search and retrieval system as a basis for storing, indexing referring to and querying for relevant hyperlinks In contrast to traditional search engines which rely almost entirely on the content of the hyperlinked documents themselves as a basis for storing and querying, the present invention is flexible enough to store these discovered hyperlinks on informational networks with a compound of one or all of potential contextual features of the user-generated content that users produce, such as time of postings and sharings, location of users who share, temporarily sensitive content of messages that mention a URL, thereby providing additional dimensionality that is difficult to represent in a traditional search system.

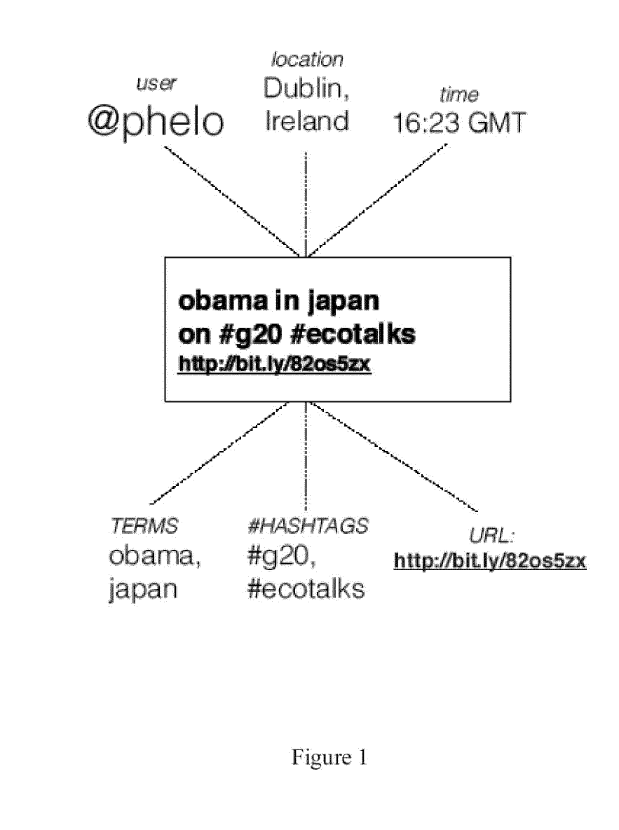

In an embodiment of the present invention as shown in FIG. 1, a sample user of a real time web source, in this example Twitter™ posts a message. In this example, the user is @phelo, and the message posted comprises a User Resource Locator (URL), “http://bit.ly/S2OsSzx” with a set of text “Obama in Japan on #G20 #ecotalks”. The location of the user is Dublin, Ireland, and the time at which the message was posted is recorded as 16.23 6MT. The terms #G20 and #ecotalks are examples of “hashtags”. Hashtags are a community/user-driven convention for adding additional context and metadata to tweets and are used as a means of creating groupings on Twitter.

In accordance with the present application, the URL is extracted, resolved (expanded to e.g. www.cnn.com/obama.html) and stored. Many existing search engines are directed to the use of content of that URL as a basis of the search index, i.e. www.cnn.com/obama.html. In accordance with the invention, the surrounding text, namely “Obama in Japan on #G20 #ecotalks” rather than the content of the URL is used as the basis of a search index.

In an alternative configuration, such an index also takes into account the time data of when the tweet was published. It will be appreciated other data such as location, user profile details, expanded content mined from similar items such as new text found alongside similar content in other messages or device details may be used in addition to, or in place of, the time data.

In the example shown in FIG. 1, the user location (Dublin) and/or the time data (16.23 6MT) can be used with the surrounding text to form a suitable index.

In an alternative embodiment, and to further increase the effectiveness of the index, posts by other users, which contain the same URL, are used to augment the index. For example, posts from a curated set of users may be searched for content that contain the same URL. Curation may be based on a set of users who are accessing the same social networking or informational networks, or those users who post on a selection or set of social networking or informational networks. Users can also curate sources based on user or content recommendations, keyword and hashtag searches for example “curate me a real-time list of results based on the hashtag #obama”. Curated lists can be shared and edited amongst one or more users.

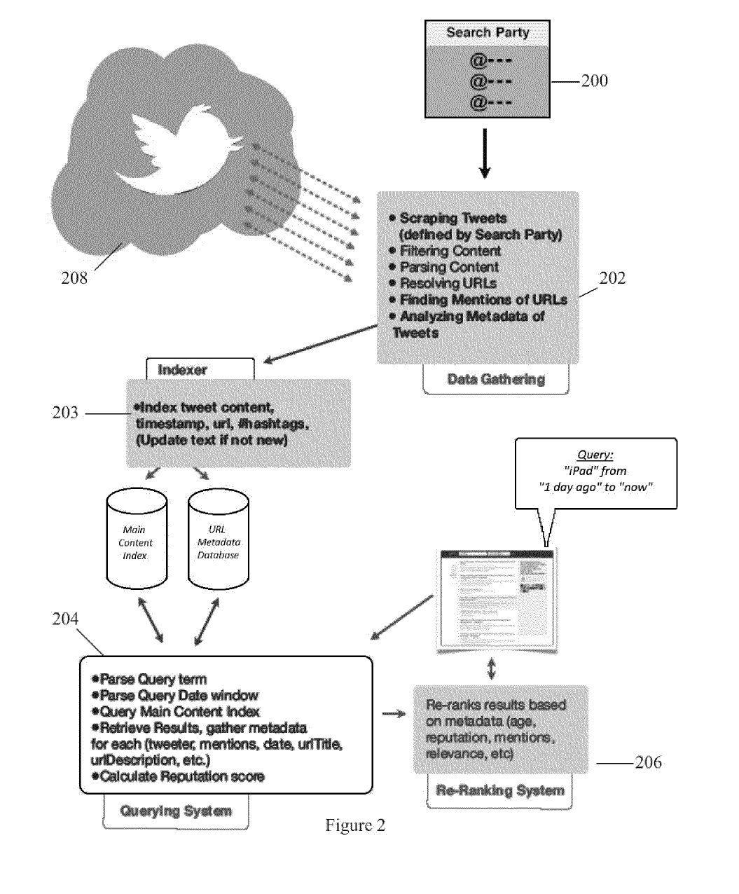

The surrounding set of text, the additional information, e.g. time and location, if used, and the results of the additional users, if used, are contextual metadata. In a further configuration described below in relation to FIG. 2, this contextual metadata can be stored so that a system in accordance with the invention can perform content ranking and re-ranking

In a typical search system, a user may query the term “obama” and the relevant content will be returned based on a ranking strategy. An example of such a strategy is GOOGLE™, PageRank.

Referring to FIG. 2, an exemplary system 2 comprises one or more search parties or search groups, 200, a data gathering component, 202, an indexing component, 203, a querying component, 204, and a re-ranking component, 206. The system uses posted and shared content, posted by users of a real time network, 208, that contain hyperlinks as the basis of an index of WebPages, the main content of which is based on user-generated text included with each hyperlink. In FIG. 2, the real time network shown in Twitter, however, it will be appreciated that this system may be used with alternative real time networks.

These components may be implemented individually or may be combined. For example, the data gathering component and the indexing component may be combined, while the querying component and the re-ranking component may form a separate combination.

Curated lists of users are called search parties or search groups, 200. Search parties are groups of users or sources and can be curated on an ad-hoc basis, automatically or manually based on common features such as their content being similar or relevant to a topic or group, or based on contextual features such as location. Groups of users who form search parties may be grouped from participants of a given social networking platform or from participants of a plurality of social networking platforms. Participation in search parties may be curated based on the interests of these users, which may be determined based on their account preferences, their reliability, the subject matter of their post, or any other features. Curation can also be based on a combination of these features. It will be appreciated that the selection criteria above are exemplary only and any combination of characteristics may be used to create a search group of users. An example of such a search group is a curated list of Twitter™ users who have posted information that is related to, or indeed who talk about a given domain. Curation parameters or selection criteria are selectable and determinable by a user of the system. For example, a user of the system may curate dedicated search engines for personal and community use based around a domain specific topic. For example, a seed list of 140 users discussing technology and who list in Twitter's feature list under a technology category can be considered a search group. Users can be members of multiple search parties.

Posts from one or more search parties can be incorporated into the system of FIG. 2. In the embodiment shown, each search party is individually indexed, however, the system is not restricted as such.

If more than one member of a search party posts the same piece of content, the message content is extracted for indexing, creating a collaborative tagging system to describe a resource. If another user who is not a member of a search party shares the same link their message is not indexed but can be stored to subsequently infer item popularity. Taking the example of FIG. 1 and applying to the system of FIG. 2, the user inputs the message “Obama in Japan on #G20 #ecotalks” into the social/informational network such as Twitter™. This message is captured by the system of FIG. 2, based on either the publishing user being part of an original search party, or the user's content is captured based on a keyword/hashtag search. Alternatively, the hyperlink posted may be similar to other hyperlinks contained in the main system index.

To create an index based on the message input as in FIG. 1, the data-gathering agent, 202, scrapes either a domain of posts or related tweets from all posts on the real time network, in this example Twitter™, or a subset of the total stream of posts. The participants in the search party or search parties define this domain of tweets or posts. The data gathering agent, 202 can be adapted to ‘listen’ to the public stream, or sources can be curated based on user lists, keywords, geographical metadata or algorithmic analysis of relevant, interesting or important content. Content related to the original message is filtered, parsed, and their original hyperlink is resolved.

Once the content is gathered, this content is then stored and indexed by the indexer, 203. The indexer, 203 also carries out real-time language classification and finds related messages that contain the same URL so the system can calculate item popularity. The indexer, 203, is responsible for extracting metadata regarding the posts or tweets, for instance timestamp data, hashtags (#obama, etc.), user profile information, location, etc, as well as the message content itself.

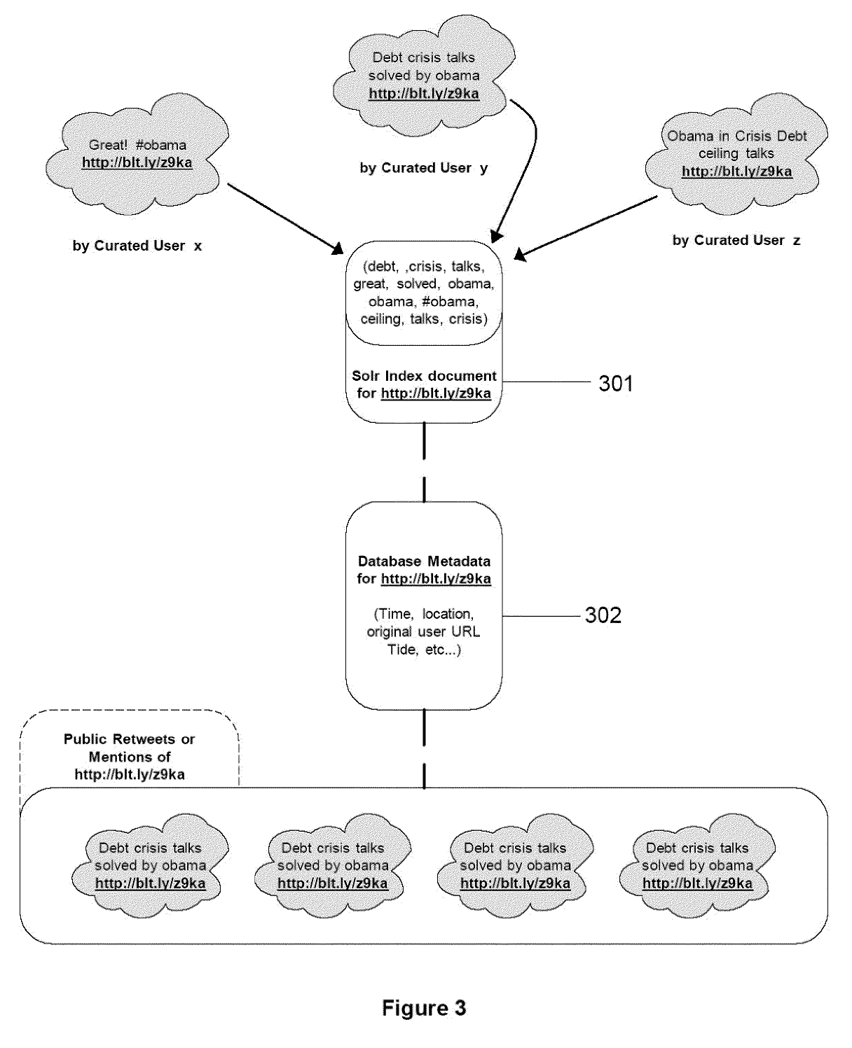

An example of the indexing process is outlined in FIG. 3. Content is originally captured in the based on the system described above. The hyperlinks contained in each message that is gathered are resolved, and stored. Surrounding text and contextual data contained in the message is then captured in block 301. A database, 302 stores the metadata relating to the URL. An indexable document-based system containing a range of content related to the URL is thus captured. This indexed document contains any data that the original curated users have mentioned. It will be appreciated that the database, 302, contains data from messages that were both from the curated list and other users who are part of the original informational/social network.

Referring to the system of FIG. 2, the main content of the post or tweet is pushed to the indexer, 203, for storage and indexing. The URL or an identifier for the URL, urlID mentioned in the message is also pushed to the indexer, 203. The set of text surrounding the URL is used in conjunction with information obtained from curated users x, y and z and metadata to create an index. Remaining extracted metadata e.g. time, location, original user, URL Title, etc is also stored in a database.

The context indexes and databases used allow for a quick and programmable way of querying content, and also provides a convenient method of gathering associated metadata for the presentation of a contextual query, re-ranking based on metadata or further metadata for presentation to the user.

With the input information stored and indexed, this information is available for query in accordance with the present invention. The fourth component of the system of FIG. 2 is the querying subsystem, 204.

A query string is used to query the stored and indexed data. A query string is entered via an interface or temporal window. The interface in the system of FIG. 2 is a graphical user interface, 208. The system can be either a remote Web service, or a local application on any computer system (PC, Laptop, Tablet, Mobile device, etc.).

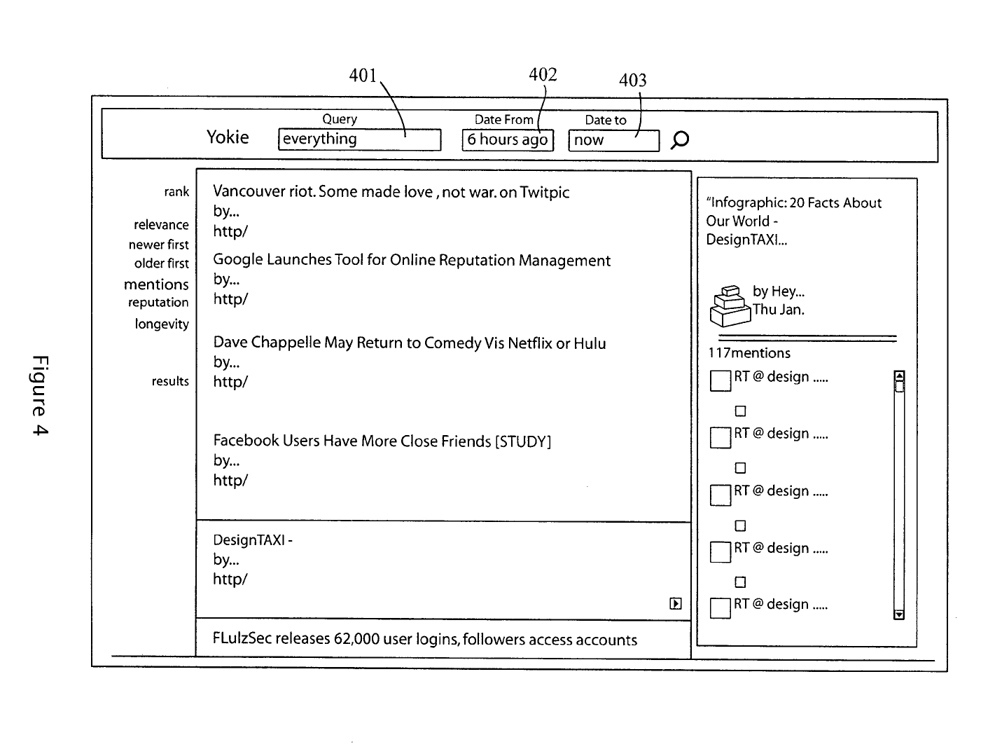

The User Interface allows users to drill-down on results to explore related content such as the original tweet that the URL was shared with, the time and day it was shared, and the related Tweet mentions (if any). This can be done, for example, via a secondary display element in the interface, such as a modal window. A sample user interface is shown in FIG. 4.

The querying component of the system allows users to add extra contextual filters in addition to query strings. In the embodiment shown, these are in the form of a temporal window (between two dates). A range of contextual features is extracted from shared content based on the query. The query interface of FIG. 4 therefore comprises a query string field, 401 and two temporal fields, “date from”, 402 and “date to”, 403. As shown, the input in the query string field, 401, is “everything”. The temporal fields, 402, 403 are implemented to provide a time range within which the search is implemented. In the example shown the time window is defined by the temporal fields, 402, 403 to be from “6 hours ago” until “now”. The full search is defined by the three fields to return all messages posted in the 6 hours previous to the search or query being commenced. An alternative query string with an associated time window can also incorporate either a natural language query (e.g. “1 day ago”, “now”, “last week”, etc) or a fixed date (“12 Dec. 2010”).

It will be appreciated that alternative configurations of the query interface may be used, the configuration of which is user configurable, or selectable. Advanced options or selections can be made to expand the number of fields or alter the search criteria. In an alternative configuration, the system can also adaptively discover new data features related to the system as they become available, for example as new features or new information is made publicly available by the real time or social network.

The querying subsystem, 204, parses user queries. In the configuration of FIGS. 2 and 4, the query is based on a triple {Querystring, Tmax, Tmin}. Alternative combinations for the query can also be used. Additional content or contextual features can also be added to a vector of query terms and data points, for example by expanding the triple into a multinomial or multidimensional query.

A natural language date string is used in the embodiment of FIGS. 2 and 4. The natural language date string is then parsed into a computer readable format. In an example, the string is “1 week ago” to “1 hour ago”. When parsed into a computer-readable format (e.g. 12 June 30 2011 12:31:41 this translates to the UNIX timestamp of 1307881901).

Users can specify specific dates, as well as special keywords such as “yesterday” (12 am the day before), and “now”. The query is pushed to the querying subsystem, and a set of database ID's of URLs are returned, urlID's. The querying system takes these resulting urlID's and finds complete database objects for each URL that are stored in the database subsystem, 302. As shown in FIG. 4, these objects contain pertinent metadata for the URL, its title, expanded hyperlink, description, as well as the surrounding Tweet content related to the initial tweet that mentioned it.

The query that the user performs may contain a triple/multiple of features including at least a keyword, followed by a set of one or more contextual features such as a date range, location, user, topic, relevance, reputation score range, etc. The system queries an index of content that contains each of these features. The system then uses a related id from the relevant items returned in the results of the query of the index to cross reference the database that contains other metadata features so as to present and rank the data. It also finds related messages that contain the same hyperlink from other users that may or may not be part of the original search party. At querying time, the system can use the expanded metadata from the database to rerank the vector of URLs based on the users' specified ranking strategy as described below.

Traditional Information Retrieval, IR systems, such as that in Fabrizio Sebastiani et al, Machine Learning in Text Categorization”, ACM Comput. Surv., 31:4-47, March 2002, use Term Frequency Inverse Document Frequency metrics (TFxIDF). This may be termed relevance. Relevance may be computed at retrieval time by the indexing subsystem. The indexing component, 203 of the present system may rank items based on relevance. Alternatively or in addition to this native ranking, items may also be ranked algorithmically post retrieval-time using one or more ranking strategies. additional strategies may include

Item Age (Older First, Newer First)

Content that is posted to social networking sites such as Twitter™ is timely indexed. Therefore, items or posts can be ranked Item Age, either ascending or descending, i.e. Users can selectively rank the list based on newer and older items. It will be appreciated that this is particularly useful in the context of the temporal window, as users may query between a certain date or time and “now”, then rank by newer first. This will give the end user a near-real time updating of content related to the query.

Item Popularity (Mentions)

When the data-gathering agent receives an item, searches are also implemented to search the social networking site for related tweets, i.e. mentions of the same URL. The greater the number of unique mentions of a given URL inside the query time-window, the more popular the item. These related tweets can be sourced from the public feed, as well as or in addition to the users of the curated Search Party.

Item Longevity

Longevity describes the total length of time an item appears in the domain, i.e. the amount of time between the first mention/activity and last mention/activity of the item. This score may apply for items that have more than one occurrence in the set. For example, a given URL, U has a longevity score of I, which is based on the difference between the Unix timestamp of the latest mention Tmax and the first mention Tmin.

Reputation

As described above, reputation is increasingly considered in recommender systems and search contexts. Items from more reputable users are placed higher in a descending list. In such an iteration of the system, a shallow summation of the total potential audience of the URL is used based on the sum of follower counts of each person in the curated domain list. Follower relationships in Twitter™ directed graph structure of social network topography might reflect in a form of promotion or voting in favour of a person to follow. In an alternative configuration comprehensive reputation scoring may be based on a combination of graph analyses and topic detection. Added contextual data from messages posted enables interesting and relevant ways of ranking content over traditional approaches, as well as interesting item discovery opportunities. This also may be used to either rank based on a compound of related ITEM reputation from other members of the curated list who have shared the given item.

Location of Sharer

It is possible for the user who shares the hyperlink to publish their location. A ranking strategy can be employed to rank the results based on the distance of the user to the current context of the searcher, or other geo-encoding mathematical algorithms that may calculate new locational features.

Location of Item

This is similar to “Location of Sharer” except an algorithm is used to derive potential related locations that are described in the text/resource of the shared message (eg a Tweet about Ireland).

Item Interestingness

Experts in the field of Information Retrieval have grappled with developing a scoring technique to metric an item's Interestingness. A multitude of features in the algorithm, can be used to represent both contextual features of the query, and past user interactions from other system users. As such, Interestingness of an item, given the Query Q tuple, as defined as:

$$Int ( {U}_{i} , Q ) = ( \frac{Pop ( {U}_{i} , Q )}{Lng ( {U}_{i} , Q )} ) \cdot ( \frac{\vert {Clk}_{∀ {U}_{i}} \vert}{\vert {Hov}_{∀ {U}_{i}} \vert} ) \cdot \vert {Lk}_{∀ Ui} \vert \qquad ( 1 )$$

Where Pop(Ui,Q) and Lng(Ui,Q) are the popularity and longevity of the current item Ui, given the parameters of the query tuple, (which means its value is dependent on the query Tmax and Tmin values), |Clk_{∀Ui}|, |Hov_{∀U}_{ᵢ}| |and |Lk_{∀Ui}| represent the total number of clicks, hovers and likes for the item, irrespective of the query parameters. These values may have a default value of 1 so as to avoid null values for interestingness of items with no user engagement.

Klout of Original Publisher

Klout is an online service that provides users of social networks an influence score based on user reach, engagement and their ability to drive other interactions 6. Using the Klout API, we can gather scores for each user (once Klout has a score computed for them). It is possible to rank content based on the publishers/sharers Klout score.

Within the user interface of FIG. 4, when results are presented to the user post query, the user can be presented with an option to “peek” at extra metadata relating to the URL, as shown in the screenshot in FIG. 4, or click on the item in a traditional fashion to visit the page.

A re-ranking menu can also be presented in the user interface of FIGS. 2 and 4, that allows users to re-rank the results as further described below. Such an interface provides a value add for users and motivate participation. Exemplary ranking strategies including Relevance, Newest first, Oldest first, Popularity, Reputation and Longevity were discussed above. When presented with the results, end users of the system may re-rank using a preferred strategy, selected from a selection of strategies rather than the benchmark relevance metric.

The user interface may also allow the end user to reformulate their query by modifying the query parameters. For example, the end user may choose to modify the time parameters and refresh the query thereby obtaining an amended set of results. The system as shown allows user generated content to be directly injected as a basis for storing, indexing, referring to and querying for relevant hyperlinks, thus reducing the system overhead required to implement an efficient search. The system presented provides flexibility to store discovered hyperlinks on informational networks with a compound of one or all of potential contextual features of user generated content, thereby giving additional dimensionality that is difficult to represent in a traditional search system.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal that may be transmitted via an electrical or an optical cable or by radio or other means.

The invention is not limited to the embodiments hereinbefore described but may be varied in both construction and detail.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub combination.

1. A method of storing data indicative of a message posted in a real time or informational network, the data comprising information identifying a uniform resource locator, URL, and textual information associated with the URL, the method comprising:
storing at least the information identifying the URL in a database;
extracting the textual information from the data; and
generating a search index for the database based on the extracted textual information.

2. The method of claim 1 wherein storing at least the information identifying the URL further comprises extracting, resolving and storing the URL based on the information identifying the URL.

3. The method of claim 2, wherein the data further comprises metadata associated with the posted message, and wherein generating the search index is further based on the metadata.

4. The method of claim 3 wherein the metadata comprises at least one of time information relating to the time the message was posted in the real time or informational network, location information, user profile details, details of a device on which the message is input and additional related information.

5-7. (canceled)

8. The method according to claim 1, further comprising:
searching the real time or informational network for additional content relating to the URL; and
augmenting the search index based on the URL.

9. (canceled)

10. The method according to claim 1, further comprising:
selecting a search group of one or more users of a social network;
searching the search group for additional content relating to the URL; and
augmenting the search index based on the URL.

11-12. (canceled)

13. The method according to claim 10, wherein the users are selected based on user preferences including at least one of user interests, posted message topic, reliability, user or content recommendations, keyword searches, hashtag searches, location information or analysis of information posted by the users of the real time or informational network.

14-15. (canceled)

16. A non-transitory computer readable storage medium having computer executable instructions stored thereon, the instructions adapted to cause a processor to:
store data indicative of a message posted in a real time or informational network, the data comprising information identifying a uniform resource locator, URL, and textual information associated with the URL, including instructions that cause the processor to:
store at least the information identifying the URL in a database;
extract the textual information from the data; and
generate a search index for the database based on the extracted textual information.

17. A system for storing data indicative of a message posted in a real time or informational network, the data comprising information identifying a uniform resource locator, URL and textual information associated with the URL, the system comprising:
means for extracting the textual information from the data; and
means for generating a search index for the message based on the extracted textual information.

18-25. (canceled)

26. The system according to claim 17, and further comprising:
means for selecting a search group of one or more users of the real time or informational network;
means for searching the search group for additional content relating to the URL; and
means for augmenting the search index based on the URL.

27-30. (canceled)

31. The method of claim 1, further comprising:
parsing a search string into a computer readable format;
comparing the parsed search string with the generated search index; and
obtaining a search result from the indexed database based on the results of the comparing the parsed search string with the generated search index.

32-49. (canceled)

50. The system of claim 17, further comprising:
means for parsing a search string into a computer readable format;
means for comparing the parsed search string with the search index; and
means for obtaining a search result from an indexed database based on the results of the comparing the parsed search string with the search index,
wherein the indexed database comprises data indicative of a message posted in a real time or informational network, the data comprising information identifying a uniform resource locator, URL, and textual information associated with the URL,
wherein at least the information identifying the URL is stored in the indexed database, and
wherein the search index is generated based on textual information extracted from the data.

51-67. (canceled)

68. The system of claim 17, further comprising:
means for gathering data indicative of a message posted in a real time network, the data comprising information identifying a uniform resource locator, URL and textual information associated with the URL;
means for generating a search index for the gathered data;
means for querying the indexed data; and
means for ranking the queried data.

69. (canceled)

70. The system of claim 68, wherein the means for gathering the data comprises:
means for storing at least the information identifying the URL in a database; and
means for extracting the textual information from the data,
wherein the means for generating the search index is configured to generate a search index for the database based on the extracted textual information.

71. The system of claim 70 wherein the means for storing at least the information identifying the URL further comprises:
means for extracting,
means for resolving and
means for storing the URL based on the information identifying the URL.

72. The system of claim 68, wherein the data further comprises metadata associated with the posted message, and wherein the means for generating the search index further comprises means for generating the search index based on the metadata.

73. The system of claim 72 wherein the metadata comprises at least one of time information relating to the time the message was posted in the real time or informational network, location information, user profile details, device details and additional related information.

74-76. (canceled)

77. The system according to claim 70, further comprising:
means for searching the real time or informational network for additional content relating to the URL; and
means for augmenting the search index based on the URL.

78. (canceled)

79. The system according to claim 70, further comprising:
means for selecting a search group of one or more users of the real time or informational network;
means for searching the search group for additional content relating to the URL; and
means for augmenting the search index based on the URL.

80-83. (canceled)

84. The system according to claim 68, wherein the means for querying the indexed data comprises:
means for parsing a search string into a computer readable format;
means for comparing the parsed search string with the generated search index; and
means for obtaining a search result from the indexed data based on the results of the comparing the parsed search string with the generated search index

85-101. (canceled)
